(19) United States
(12) Patent Application Publication
(10) Pub. No.: US 2020/0391669 A1
(43) Pub. Date: Dec. 17, 2020

(54) DISPLAY SYSTEM FOR A VEHICLE

(71) Applicant: Faraday&Future Inc., Gardena, CA (US)

(72) Inventors: Pontus Anthony Fontaeus, Newport Beach, CA (US); Claudio Carbone, Los Angeles, CA (US); Taeho Kim, South Pasadena, CA (US); Christoph Kuttner, Ladera Ranch, CA (US)

(21) Appl. No.: 16/090,564

(22) PCT Filed: Apr. 1, 2017
(86) PCT No.: PCT/US2017/025661

§ 371 Date: Oct. 1, 2018

Related U.S. Application Data
(60) Provisional application No. 62/317,411, filed on Apr. 1, 2016.

(51) Int. Cl. B60R 11/02; H05K 5/00

(52) U.S. Cl. CPC B60R 11/0229; B60R 2011/0005; H05K 5/0017

(57) ABSTRACT

A display system for a vehicle may include a display having a screen configured to display an image, and a mounting mechanism coupled to a rear surface of the display. The mounting mechanism may include an actuator pivotally coupled to the rear surface of the display at a first point and configured to extend and retract relative to an interior surface of the vehicle. The mounting mechanism may also include a link having a first end pivotally coupled to the rear surface of the display at a second point spaced from the first point, and a second end configured to be pivotally coupled to the vehicle, the first and second points defining an axis. The mounting mechanism may be configured to reorient the display between a first orientation and a second orientation, such that the axis defined by the first and second points pivots relative to the interior surface of the vehicle.

### CROSS REFERENCE TO RELATED APPLICATIONS

The present application claims the benefit of U.S. Provisional Application No. 62/317,411, filed Apr. 1, 2016, the entirety of which is hereby incorporated by reference.

### TECHNICAL FIELD

The present disclosure relates generally to a display system for a vehicle, and more particularly, to a display system for a vehicle configured to reorient a display.

### BACKGROUND

Vehicle manufacturers have made a number of attempts to increase the interactivity with vehicle occupants. For example, more recent vehicles often include displays that provide the occupants with information, such as traffic reports, weather reports, and general infotainment. The display is typically rigidly integrated into the dashboard of the vehicle, such that the display can be viewed by an occupant in the driver seat.

However, this fixed design may result in a number of possible drawbacks. For instance, the rigid integration of the display into the dashboard may be at a suboptimal viewing angle for at least some drivers. The displays may often be relatively far from the driver, making it difficult to read smaller text or features on a map. The fixed design may also prevent the occupants from adjusting the distance and/or viewing angle of the display based on the status of the vehicle or preferences of the occupants. Furthermore, the displays may occupy a significant amount of space on the dashboard, even when not in use, which may compromise the aesthetics of the interior of the vehicle.

The disclosed display system may be directed to mitigating or overcoming one or more of the drawbacks set forth above and/or other problems in the prior art.

### SUMMARY

One aspect of the present disclosure is directed to a display system for a vehicle. The display system may include a display having a screen configured to display an image, and a mounting mechanism coupled to a rear surface of the display. The mounting mechanism may include an actuator pivotally coupled to the rear surface of the display at a first point and configured to extend and retract relative to an interior surface of the vehicle. The mounting mechanism may also include a link having a first end pivotally coupled to the rear surface of the display at a second point spaced from the first point, and a second end configured to be pivotally coupled to the vehicle, the first and second points defining an axis. The mounting mechanism may be configured to reorient the display between a first orientation and a second orientation, such that the axis defined by the first and second points pivots relative to the interior surface of the vehicle.

Another aspect of the present disclosure is directed to a method of reorienting a display. The method may include extending or retracting an actuator coupled to the display relative to an interior surface of the vehicle, and pivoting the display relative to the interior surface of the vehicle during the extending or retracting via a link pivotally coupled to the display.

Yet another aspect of the present disclosure is directed to a vehicle. The vehicle may include an interior surface, and a display system coupled to the interior surface. The display system may include a display having a screen configured to display an image, and a mounting mechanism coupled to a rear surface of the display and the interior surface. The mounting mechanism may include an actuator pivotally coupled to the rear surface of the display at a first point and configured to extend and retract relative to the interior surface. The mounting mechanism may also include a link having a first end pivotally coupled to the rear surface of the display at a second point spaced from the first point, and a second end configured to be pivotally coupled to the vehicle, the first and second points defining an axis. The mounting mechanism may be configured to reorient the display between a first orientation and a second orientation, such that the axis defined by the first and second pivot points pivots relative to the interior surface of the vehicle.

### BRIEF DESCRIPTION OF THE DRAWINGS

FIG. 1 is a diagrammatic illustration of an exemplary vehicle interior, according to an exemplary embodiment of the disclosure.

FIG. 2 is a diagrammatic illustration of a first exemplary orientation of an exemplary embodiment of a display system that may be used with the exemplary vehicle of FIG. 1.

FIG. 3 is a diagrammatic illustration of a second exemplary orientation of the exemplary display system of FIG. 2.

### DETAILED DESCRIPTION

The disclosure is generally directed to a display system for a vehicle including a display that may be reoriented relative to an interior surface of the vehicle. The display system may be located in the vicinity of a dashboard between a driver seat and a front passenger seat. The display system may include a mounting mechanism configured to reorient the display from a first deactivated orientation to a second activated orientation. The display may be adjustable in height and/or viewing angle in order to optimize screen visibility. The display system may be applied to many types of vehicles, such as automobiles, trains, planes, and boats.

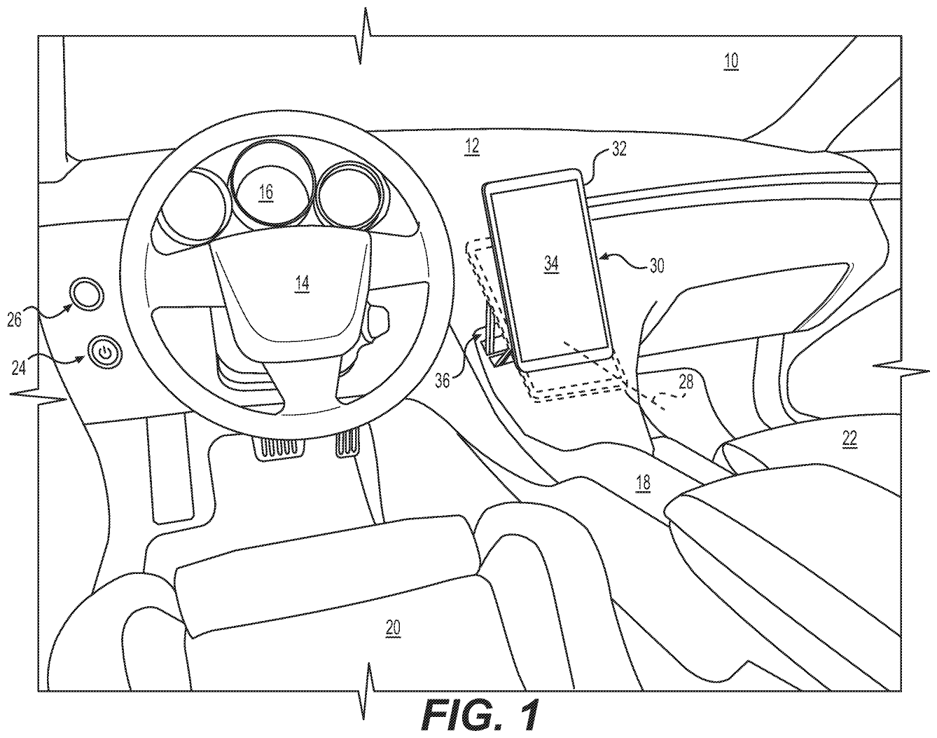

FIG. 1 is a diagrammatic illustration of an exemplary embodiment of a vehicle 10. As illustrated in FIG. 1, exemplary vehicle 10 may include an interior surface, such as a dashboard 12 that may house or support a steering wheel 14 and an instrument panel 16. Dashboard 12 may include a substantially vertical surface extending to another interior surface of vehicle 10, such as a center console 18. Vehicle 10 may also include a driver seat 20 and a passenger seat 22 configured to accommodate occupants and which may be separated by center console 18. Vehicle 10 may also include a vehicle input 24 (e.g., a push button actuator) that may activate various systems of vehicle 10, such as, for example, its electrical system and/or motor. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomously.

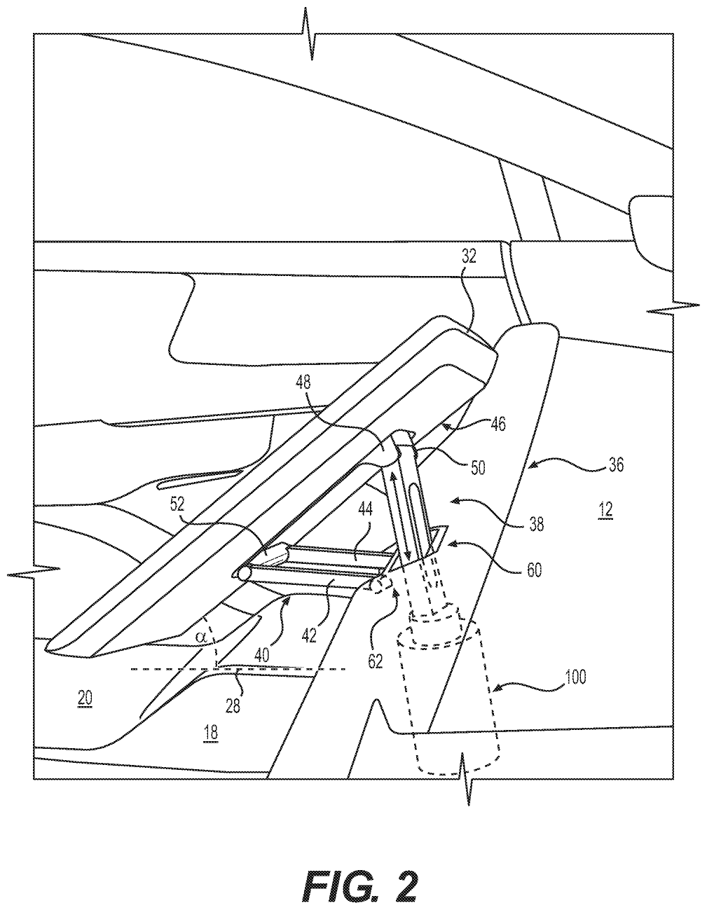

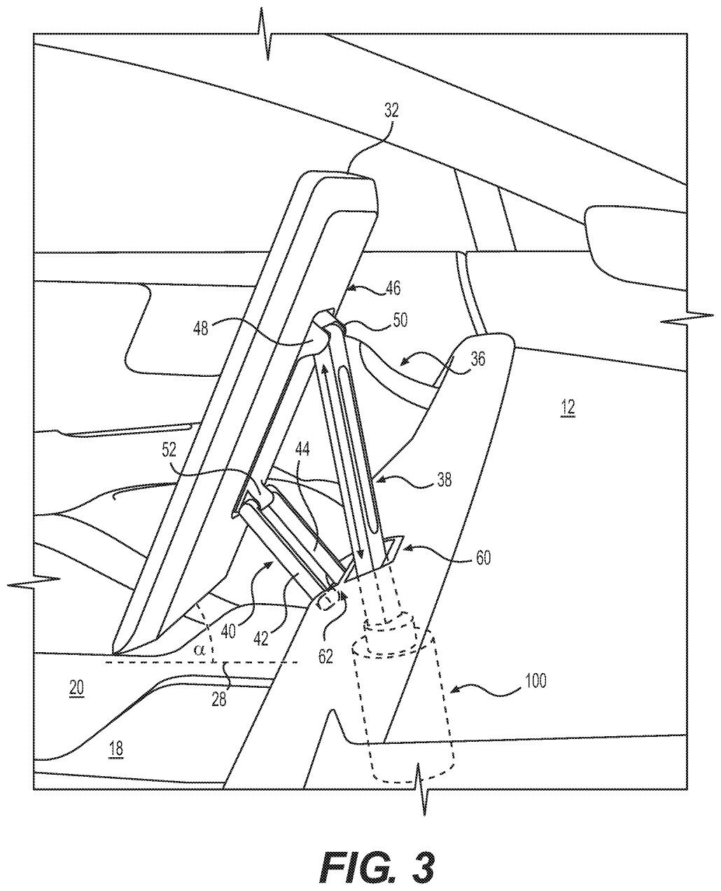

Vehicle 10 may also include a display system 30 coupled to an interior surface of vehicle 10, such as dashboard 12. Display system 30 may be positioned between driver seat 20 and passenger seat 22 to be viewed by occupants. Display system 30 may include a display 32 having a screen 34 configured to display an image. Display system 30 may also include a mounting mechanism 36 configured to reorient display 32 from a first orientation (depicted as dotted lines in FIG. 1, and in FIG. 2) and a second orientation (depicted as solid lines in FIG. 1, and in FIG. 3). Screen 34 may be exposed in both the first orientation and the second orientation, for example, such that screen 34 is not recessed within dashboard 12. Display system 30 may be controlled through actuation of vehicle input 24 and/or a display input 26, for example, based on user-defined settings. For example, pressing vehicle input 24 and/or display input 26 may activate screen 34 and may actuate mounting mechanism 36 to reorient display 32 from the first orientation to the second orientation.

Display 32 may include an LCD, an LED, a plasma display, or any other type of display. Display 32 may also provide a graphical user interface (GUI) presented on the screen 34 for user input and data display. Display 32 may further include input devices, such as a touchscreen, a keyboard, and/or a tracker ball. Display 32 may also be configured to receive user-defined settings.

FIG. 2 is a diagrammatic illustration of an exemplary first orientation of exemplary display system 30. As illustrated in FIG. 2, the first orientation of display system 30 may provide display 32 in a reclined configuration (e.g., relative to a horizontal plane extending through vehicle 10). For example, in some embodiments, the first orientation of display 32 may be at a vertical angle α of less than about 30° relative to a horizontal axis 28 of vehicle 10. In some embodiments, the first orientation of display 32 may be substantially flat (e.g., having a vertical axis α of less than about 10°). As further depicted in FIG. 2, display 32 may also be angled with respect to a vertical axis (not shown) in a direction toward driver seat 20. The second orientation may represent a configuration where screen 34 is disabled, in a sleep mode, and/or in an otherwise energy-saving mode. The first orientation may also reduce any obstruction that display 32 may impose, and maintain functional space on dashboard 12 that may be used, for example, for storage.

As illustrated in FIG. 2, exemplary mounting mechanism 36 may include an actuator 38 configured to extend and retract with respect to a first opening 60 in dashboard 12, such that at least a portion of actuator 38 is configured to be recessed in dashboard 12. The movement of actuator 38 may be effectuated by a motor 100 recessed in dashboard 12 and coupled to a first end of actuator 38. In some embodiments, motor 100 may be configured to extend and retract actuator 38 only along a straight path relative to dashboard 12, such that actuator 38 does not pivot or rotate relative to dashboard 12. A second end of actuator 38 may be pivotally coupled to an upper support member 46 associated with a rear surface of display 32. For example, the second end of actuator 38 may be received between a first projection 48 and a second projection 50 of upper support member 46, and coupled through a pin projecting from first and second projections 48, 50 through an aperture of second end of actuator 38. As motor 100 extends and retracts actuator 38 out/in in relation to first opening 60, an upper portion of display 32 may be moved away/towards from dashboard 12, for example, pivoting display 32 in an arcuate pathway.

Motor 100 may include any structure configured to extend and retract actuator 38 out and in relative to first opening 60. In some embodiments, motor 100 may include a threaded screw configured to rotate in order to extend and retract actuator 38 out/in relative to first opening 60. In some embodiments, motor 100 may include a hydraulic actuator configured to use hydraulic pressure to extend and retract actuator 38 out/in relative to first opening 60. In some embodiments, motor 100 may include a geared mechanism having teeth that interlock with respective teeth on actuator 38 (e.g., a rack and pinion mechanism), and configured to rotate the geared mechanism to extend and retract actuator 38 out/in of first opening 60.

Mounting mechanism 36 may also include a link 40 pivotally coupled to a second opening 62 of dashboard 12. For example, link 40 may include a first link 42 and a second link 44, each having a first end pivotally recessed in second opening 62, for example, through a hinge (e.g., a socket hinge). The second ends of links 42, 44 may be pivotally coupled to a lower support member 52 associated with the rear surface of display 32. For example, the second ends of links 42, 44 may include a pin that is rotatably secured through an aperture of lower support member 52. As illustrated in FIG. 2, the first orientation of display system 32 may be provided as actuator 38 is substantially retracted into first aperture 60 and link 40 is pivoted to a lower position.

FIG. 3 is a diagrammatic illustration of the second orientation of display system 30. The second orientation may position display 32 at a favorable viewing angle α relative to one or more occupants (e.g., the driver). For example, display 32 may be provided at a vertical angle α of about 60° to about 90° relative to horizontal axis 28 of the vehicle in the second orientation. Display 32 may be oriented at a slight lateral angle with respect to a vertical axis (e.g., about 10°) in a direction toward driver seat 20 to enhance viewability by the driver. In some embodiments, display 32 may also be elevated above dashboard 12, in the second orientation, to provide screen 34 at an approximate eyelevel to enhance viewability. In some embodiments, actuator 38 may be configured to extend or retract, for example, about 125 mm between the first orientation and the second orientation, and travel at a rate of, for example, about 25 mm/sec.

As depicted in FIG. 3, the second orientation is provided by motor 100 extending and retracting actuator 38 out of first opening 60, which advances the upper portion of display 32 (e.g., at upper support member 50) upwards and away from dashboard 12. As the upper portion of display 32 is advanced away from dashboard 12, the lower portion of display 30 (e.g., at lower support member 52) rotates via a coupling with link 40. For example, upper and lower support members 50, 52 may provide first and second attachment points that define an axis of display 32. The axis may pivot relative to mounting mechanism 36 and dashboard 12 as display 32 reorients between the first orientation and the second orientation. The second orientation provides a substantially upright orientation of screen 34 that may be more visible to the occupants. When moving into the second orientation, screen 34 may be configured to activate, for example, and display a welcome screen.

In some embodiments, orientation of display system 30 may be controlled by user-defined settings. For example, motor 100 may be configured to reorient mounting mechanism 36 based on a number of different inputs based one or more preferences of the user.

In some embodiments, motor 100 may be automatically initiated based on actuation of vehicle input 24, such that mounting mechanism 36 may reorient from the first orientation wherein screen 34 is deactivated to the second orientation wherein screen 34 is activated when vehicle 10 is activated. It is also contemplated that motor 100 may be initiated based on detection of the presence of a user, for example, based on detection of a mobile device within vehicle 10 or detection of an occupant through a weight sensor associated with driver seat 20.

In some embodiments, motor 100 may be initiated by manual actuation of display input 26. For example, display input 26 may include a button (depicted in FIG. 1), which may be pressed to toggle display system 30 between the first orientation wherein screen 34 is deactivated and the second orientation wherein screen 34 is activated. Although depicted to be on dashboard 12 in FIG. 1, display input 26 may, additionally or alternatively, be positioned on steering wheel 11, center console 18, display 32, screen 34, and/or any other convenient location associated with an interior surface of vehicle 10. For example, display input 26 may embody an icon of a GUI displayed on screen 34. It is also contemplated that motor 100 may be initiated through voice commands captured by a microphone of vehicle 10 and/or predefined gestures captured by a camera or sensor of vehicle 10.

In some embodiments, vertical angle α in the first and second orientations may be adjusted based on a number of different parameters. For example, vertical angle α may be adjusted based on user-defined settings and/or detection of individual occupants. For instance, drivers that are taller may prefer a smaller vertical angle α than drivers that are shorter, and mounting mechanism 36 may be configured to automatically orient to the desired vertical angle α upon detection of the individual occupant, or vice versa. The detection may be based on biometric data and/or detection of a mobile device within vehicle 10. Vertical angle α may also automatically adjust based on time of day and/or detected environmental conditions to reduce any undesirable visual effects on the visibility of screen 34. For example, mounting mechanism 36 may reduce/increase vertical angle α based on the position of the sun to reduce any undesirable shadows and/or glare.

A method of reorienting display 32 in vehicle 10 is also contemplated. The method may include extending or retracting actuator 38 coupled to display 32 relative to an interior surface of vehicle 10, such as dashboard 12. The method may also include pivoting display 32 relative to dashboard 12 during the extending or retracting via link 40 pivotally coupled to display 32. The extending or retracting of actuator 38 may include extending or retracting only along a straight path relative to dashboard 12. The method may further include reorienting display 32 from a first orientation to a second orientation, such that an axis defined by the length of display 32 pivots relative to dashboard 12. The method may even further include initiating the extending or retracting actuator 38 via activation of vehicle 10.

Even though display system 30 is depicted to be coupled to dashboard 12 centrally located between driver seat 20 and passenger seat 22, it is contemplated that display system 30 may be coupled to other interior surfaces of vehicle 10. For example, display system 30 may be coupled to other locations of dashboard 12 relative to either driver seat 20 or passenger seat 22. It is also contemplated that display system 30 may be coupled to center console 18 or positioned adjacent to rear passenger seats.

A non-transitory computer-readable medium storing instructions which, when executed, may cause one or more processors to perform methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed display system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

What is claimed is:

1. A display system for a vehicle, the display system comprising:
a display having a screen configured to display an image; and
a mounting mechanism coupled to a rear surface of the display, the mounting mechanism comprising:
an actuator pivotally coupled to the rear surface of the display at a first point and configured to extend and retract relative to an interior surface of the vehicle; and
a link having a first end pivotally coupled to the rear surface of the display at a second point spaced from the first point, and a second end configured to be pivotally coupled to the vehicle, the first and second points defining an axis,
wherein the mounting mechanism is configured to reorient the display between a first orientation and a second orientation, such that the axis defined by the first and second points pivots relative to the interior surface of the vehicle.

2. The display system of claim 1, wherein the actuator is configured to extend and retract only along a straight path relative to the interior surface of the vehicle.

3. The display system of claim 1, wherein the actuator is pivotally coupled to an upper support member associated with the rear surface of the display.

4. The display system of claim 3, wherein the actuator is coupled between a first projection and a second projection of the upper support member.

5. The display system of claim 1, wherein the link is pivotally coupled to a lower support member associated with the rear surface of the display.

6. The display system of claim 5, wherein the link comprises a first link and a second link coupled on opposite sides of the lower support member.

7. The display system of claim 1, wherein at least a portion of the actuator is configured to be recessed relative to the interior surface of the vehicle.

8. The display system of claim 1, further comprising a motor configured to extend and retract the actuator, wherein the motor is configured to be recessed relative to the interior surface.

9. The display system of claim 8, wherein the motor is configured to extend and retract the actuator based on a signal indicative of activation of the vehicle.

10. A method of reorienting a display in a vehicle, the method comprising:
extending or retracting an actuator coupled to the display relative to an interior surface of the vehicle; and
pivoting the display relative to the interior surface of the vehicle during the extending or retracting via a link pivotally coupled to the display.

11. The method of claim 10, wherein the extending or retracting of the actuator comprises extending or retracting only along a straight path relative to the interior surface of the vehicle.

12. The method of claim 10, further comprising reorienting the display from a first orientation to a second orientation, such that an axis defined by the length of the display pivots relative to the interior surface of the vehicle.

13. The method of claim 10, further comprising initiating the extending or retracting of the actuator via activation of the vehicle.

14. A vehicle comprising:
an interior surface; and
a display system coupled to the interior surface, the display system comprising:
a display having a screen configured to display an image; and
a mounting mechanism coupled to a rear surface of the display and the interior surface, the mounting mechanism comprising:
an actuator pivotally coupled to the rear surface of the display at a first point and configured to extend and retract relative to the interior surface; and
a link having a first end pivotally coupled to the rear surface of the display at a second point spaced from the first point, and a second end pivotally coupled to the vehicle, the first and second points defining an axis,
wherein the mounting mechanism is configured to reorient the display between a first orientation and a second orientation, such that the axis defined by the first and second pivot points pivots relative to the interior surface of the vehicle.

15. The vehicle of claim 14, wherein the screen is exposed relative to the interior surface in both the first orientation and the second orientation.

16. The vehicle of claim 14, wherein the display is more reclined relative to a horizontal axis in the first orientation than in the second orientation.

17. The vehicle of claim 14, wherein the actuator is configured to extend and retract only along a straight path relative to the interior surface of the vehicle.

18. The vehicle of claim 14, wherein at least a portion of the actuator is recessed relative to the interior surface of the vehicle.

19. The vehicle of claim 14, further comprising a motor configured to extend and retract the actuator, wherein the motor is recessed relative to the interior surface.

20. The vehicle of claim 19, wherein the motor is configured to extend and retract the actuator based on a signal indicative of activation of the vehicle.
